(19) United States
(12) Patent Application Publication
(10) Pub. No.: US 2009/0076855 A1
(43) Pub. Date: Mar. 19, 2009

(54) Apparatus, method and system for web-based health care marketplace portal

(76) Inventor: Matthew McCord, Brighton, MI (US)

Correspondence Address: SQUIRE, SANDERS & DEMPSEY L.L.P., 8000 TOWERS CRESCENT DRIVE, 14TH FLOOR, VIENNA, VA, 22182-6212, US

(21) Appl. No.: 12/232,240

(22) Filed: Sep. 12, 2008

Related U.S. Application Data
(60) Provisional application No. 60/960,060, filed on Sep. 13, 2007.

(51) Int. Cl. G06Q 50/00

(52) U.S. Cl. 705/3

(57) ABSTRACT

An apparatus, system, and method are provided to enable an individual to access and manage his health care via a web-based portal. The apparatus, system, and method further provide for the compiling and displaying of localized consumer health care information. In particular, the apparatus, system, and method provide a receiver configured to receive raw health information data from a health information source, and a processor configured to process the raw health information data by transforming the raw health information data into refined health information data. The apparatus, system, and method further provide a storage unit configured to store the refined health information data, and a display including a graphical user interface configured to display the refined health information data, enabling a user to access and manage health care needs of the user in a user selected geographical area.

### CROSS REFERENCE TO RELATED APPLICATIONS

This application claims priority under 35 U.S.C. §119(e) of U.S. Provisional Patent Application Ser. No. 60/960,060, filed on Sep. 13, 2007. The subject matter of the earlier filed application is hereby incorporated by reference.

### BACKGROUND OF THE INVENTION

1. Field of the Invention

The present invention relates to an apparatus, system, and method for managing personal health care. More particularly, the present invention relates to an apparatus, system, and method for providing an electronic marketplace for an individual to access and manage his health care via a web-based health care portal or application. The present invention further relates to an apparatus, system, and method for compiling and displaying localized consumer health care information, enabling the individual to locate and access health care providers and facilities in the individual's local area. The localization over a period of time enables an individual to access specialty and tourism-related information across the U.S. and the world.

2. Description of the Related Art

Studies have shown that patients have a desire to readily access and manage their own health care information. With the advent of the Internet and advancements in technology access and security, individuals are increasingly demanding access to their personal health information to allow them to monitor and manage their own health care and the services associated therewith.

With the rising costs and policy changes associated with health care management, employers are beginning to shift the responsibility of individual health care management to their employees. Accordingly, what is needed is a web-based application that provides an individual with the ability to access his personal health information and to allow him to monitor and manage his own health care and the services associated therewith.

Current web-based applications fail to provide individuals with the ability to access and manage their health care information, while further providing access to localized consumer health care information, health care providers, and health care facilities within the individual's zip code, or within a selected zip code.

Accordingly, what are needed is an apparatus, system, and method in which an individual can access and manage his health care via a web-based application, whereby the web-based application compiles and displays local consumer health information in a uniform and understandable way. Furthermore, a web-based application is needed which provides the user with the ability to locate and access health care providers and facilities in the user's local area, e.g. using the individual's zip code, and further permits the user to schedule health care services.

Furthermore, an apparatus, system, and method are needed to facilitate an inflow of health information from data sources and to consolidate and process the health information for use by an individual in managing the individual's personal health information, health care services, and health care costs. This would assist employers to shop and obtain the best healthcare pricing in a highly constrained black box pricing model.

Furthermore, an apparatus, system and method are needed to deliver health information to an individual, whereby the health information can include an individual's personal health record, and physician, physician extender, and health care facility profile information, such as whether the physician, physician extender, and/or health care facility is accepting new patients and which health insurance products are accepted, localized to an individual's zip code, facility amenities, and consumer provider ratings, and further to provide health alerts to the individual in response to individualized health care needs.

No prior arrangements have provided an apparatus, system, and method via a web-based application that provide an individual with the ability to access his personal health information and to allow him to monitor and manage his own health care and the services associated therewith, localized to the individual's zip code or preferred geographical area.

### SUMMARY OF THE INVENTION

In accordance with an embodiment of the present invention, there is provided an apparatus including a processor configured to receive raw health information data from a health information source, and to process the raw health information data by transforming the raw health information data into refined health information data. The apparatus further includes a processing storage unit configured to store the refined health information data, and a validator configured to validate and test the refined health information data for accuracy. The apparatus further includes a transmitter configured to transmit the refined health information data to a database storage unit for use by a graphical user interface to enable a user to access and manage health care needs of the user in a user selected geographical area.

In accordance with an embodiment of the present invention, there is provided an apparatus including processing means for receiving raw health information data from a health information source, and for processing the raw health information data by transforming the raw health information data into refined health information data. The apparatus further includes process storing means for storing the refined health information data, and validating means for validating and testing the refined health information data for accuracy. The apparatus further includes transmitting means for transmitting the refined health information data to a database storage unit for use by a graphical user interface to enable a user to access and manage health care needs of the user in a user selected geographical area.

In accordance with an embodiment of the present invention, there is provided a system including a receiver configured to receive raw health information data from a health information source, and a processor configured to process the raw health information data by transforming the raw health information data into refined health information data. The system further includes a database storage unit configured to store the refined health information data, and a display configured to display the refined health information data to enable a user to access and manage health care needs of the user in a user selected geographical area.

According still to another embodiment of the present invention, there is provided a method including the steps for receiving raw health information data from a health information source, processing the raw health information data by transforming the raw health information data into refined health information data, and storing the refined health information data. The method further includes steps for validating and testing the refined health information data for accuracy, and transmitting the refined health information data to a database storage unit for use by a graphical user interface to enable a user to access and manage health care needs of the user in a user selected geographical area.

According still to another embodiment of the present invention, there is provided a method including the steps for receiving raw health information data from a health information source, and processing the raw health information data by transforming the raw health information data into refined health information data. The method further includes steps for storing the refined health information data, and displaying the refined health information data to enable a user to access and manage health care needs of the user in a user selected geographical area.

According still to another embodiment of the present invention, there is provided a computer program product embodied on a computer readable medium. The computer program product is configured to control a processor to perform the steps for receiving raw health information data from a health information source, and processing the raw health information data by transforming the raw health information data into refined health information data. The computer program product is further configured to control the processor to perform the steps of storing the refined health information data, and displaying the refined health information data to enable a user to access and manage health care needs of the user in a user selected geographical area.

### BRIEF DESCRIPTION OF THE DRAWINGS

Further aspects, details, advantages and modifications of the present invention will become apparent from the following detailed description of the preferred embodiments which is to be taken in conjunction with the accompanying drawings, in which:

FIGS. 1A and 1B are schematic block diagrams illustrating a system for managing an individual's health care, in accordance with an embodiment of the present invention.

FIG. 2 is a schematic block diagram illustrating a data staging area for compiling health information, in accordance with an embodiment of the present invention.

FIG. 3 is a schematic block diagram illustrating a business engine for processing health information for a web-based application, in accordance with an embodiment of the present invention.

FIG. 4 is a home page view of a graphical user interface, in accordance with an embodiment of the present invention.

FIG. 5 is a consumer view—consumer health record page of the graphical user interface, in accordance with an embodiment of the present invention.

FIG. 6 is a consumer view—physician search results page of the graphical user interface, in accordance with an embodiment of the present invention.

FIG. 7 is a consumer view—facility search results page of the graphical user interface, in accordance with an embodiment of the present invention.

FIGS. 8A and 8B are consumer view—physician detail view including physician's (service provider) profile information pages of the graphical user interface, in accordance with an embodiment of the present invention.

FIG. 9 is a consumer view—physician detail view including physician's (service provider) appointment scheduling page of the graphical user interface, in accordance with an embodiment of the present invention.

FIG. 10 is a consumer view—facility detail view including facility's (service provider) profile information page of the graphical user interface, in accordance with an embodiment of the present invention.

FIG. 11 is a consumer view—facility detail view including facility's (service provider) appointment scheduling page of the graphical user interface, in accordance with an embodiment of the present invention.

FIG. 12 is a physician view—initial login view and alerts page of the graphical user interface, in accordance with an embodiment of the present invention.

FIG. 13 is a physician view—confirming “Is This You?” identity page of the graphical user interface, in accordance with an embodiment of the present invention.

FIGS. 14A and 14B are physician view—confirmation pages of the graphical user interface, in accordance with an embodiment of the present invention.

FIG. 15 is a physician view—biographical information entry page of the graphical user interface, in accordance with an embodiment of the present invention.

FIG. 16 is a physician view—professional information entry page of the graphical user interface, in accordance with an embodiment of the present invention.

FIG. 17 is a physician view—office information entry page of the graphical user interface, in accordance with an embodiment of the present invention.

FIG. 18 is a facility view—office information entry page of the graphical user interface, in accordance with an embodiment of the present invention.

FIG. 19 is an example of a health information processing method, in accordance with an embodiment of the present invention.

FIGS. 20A, 20B, and 20C are flow diagrams for a user registration process, in accordance with an embodiment of embodiment of the present invention.

FIGS. 21A and 21B are healthcare support forum pages, in accordance with an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

The present invention combines electronic hardware and software components to create an apparatus, a system, and a method for providing an electronic marketplace for an individual to access and manage his health care via a web-based portal or application. The present invention further creates an apparatus, a system, and a method for compiling and displaying localized consumer health care information, enabling the individual to locate and access appropriate health care providers and facilities in the individual's local area, or in a preferred geographical area.

Federal laws have been created to give individuals rights to their medical information and to protect the privacy and accessibility of an individual's health record. Under the Health Insurance Portability and Accountability Act (“HIPAA”), enacted by Congress in 1996, an individual can view, request changes to, and obtain electronic or paper copies of health information collected and kept for the individual. HIPAA also provides protections regarding how a health care provider can use the individual's health care information.

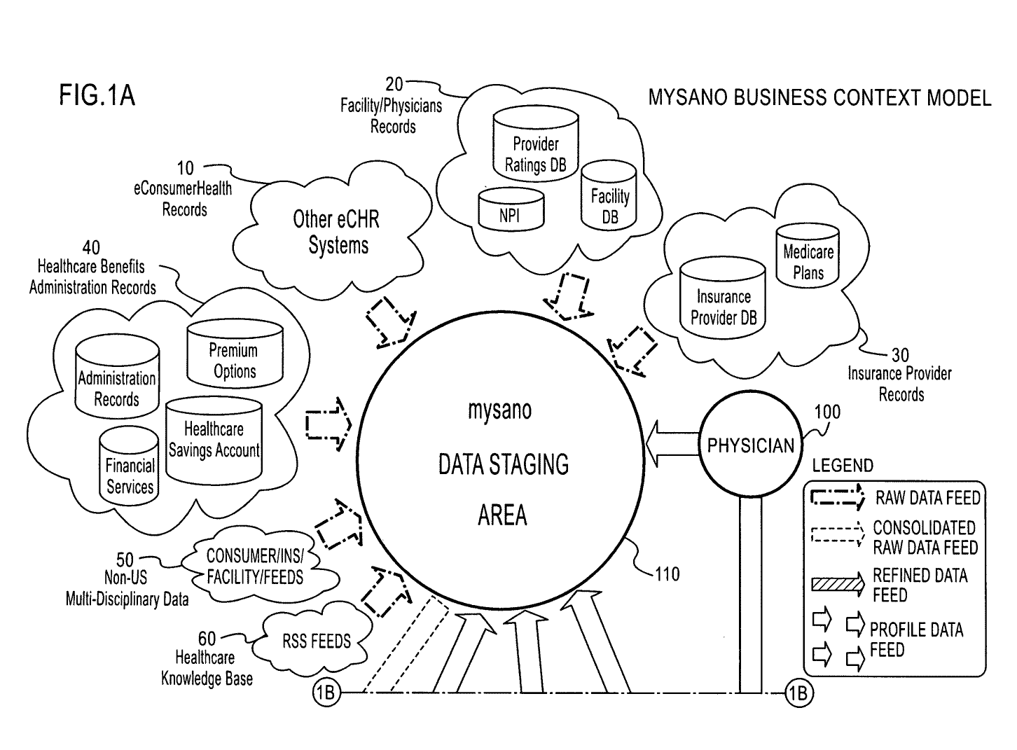

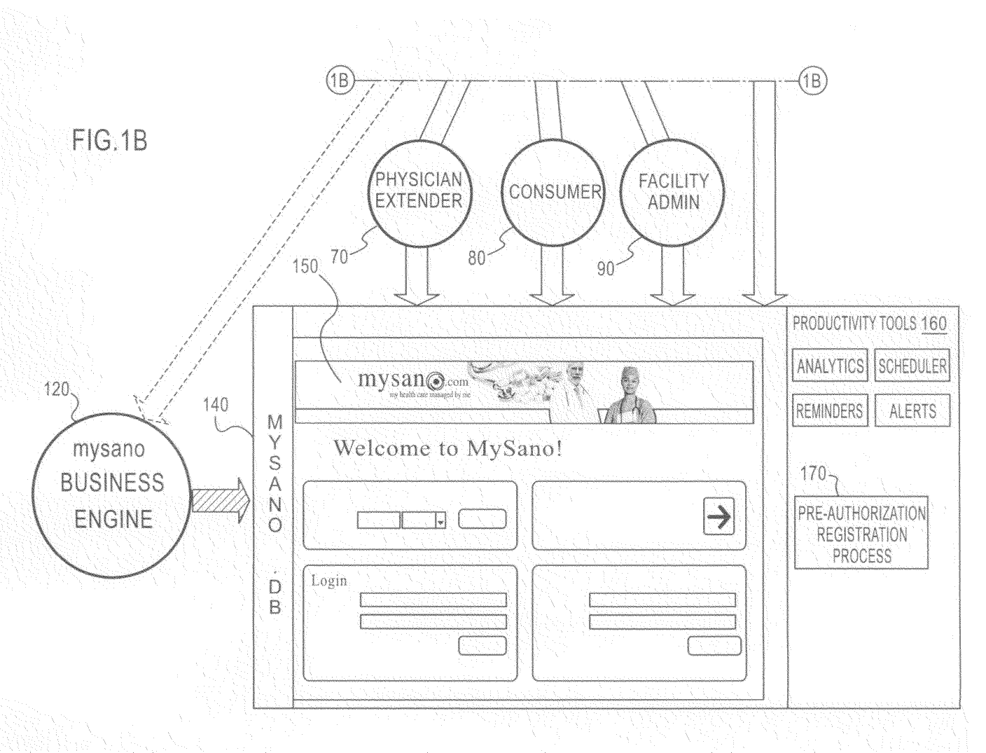

FIGS. 1A and 1B are schematic block diagrams illustrating a system, such as the Mysano Business Context Model, for managing an individual's health care, in accordance with an embodiment of the present invention. System 5 includes a plurality of health information sources, a data staging area, a business engine, and a graphical user interface. The plurality of health information sources can include consumer health records 10, facility/physician/physician extender records 20, insurance provider records 30, healthcare benefits administration records 40, non-U.S. multi-disciplinary data 50, a healthcare knowledge database 60, physician extenders 70, consumers 80, facility administrators 90, and physicians 100.

Because of employer and consumer demands and the protections provided by HIPAA and consumer and employer demand for access and management of health care information, the industry has developed a variety of digital health records to provide individuals with electronic access to their health care information.

These digital health records are commonly referred to as electronic health records (“EHR”), personal health records (“PHR”), and consumer health records (“CHR”), collectively referred to as “a CHR” or “CHRs” for purposes of further explanation. A plurality of CHRs 10 can be stored in a secure database for easy retrieval and use as allowed for by the individual patient or health consumer. Examples of a CHR database can include MICROSOFT'S HEALTHVAULT™, GOOGLE HEALTH'S PHR™, and DOSSIA'S ELECTRONIC MEDICAL RECORDS™ (“EMR”).

Each CHR 10 can store an individual's medical history, exam results, and lab and test results. In particular, the CHR 10 can also include, for example, an individual's identification sheet listing the individual's name, address, telephone number, insurance, and policy number. A list of significant illnesses and operations for the individual, a list of medications prescribed for the individual, and an account of the individual's medical history can also be included. The individual's medical history can include major illnesses and surgeries, significant family history of disease, health habits, current medications, and past medical examination results. The digital health record can also include progress notes recorded by doctors, nurses, therapists, and social workers caring for the individual that reflect the individual's response to treatment, their observations, and plans/recommendations for continued treatment. Additionally, consultation notes, physician orders directed to other members of the healthcare team regarding the individual's medications, tests, diets, and treatments can also be included. The record can also include findings associated with X-rays, mammograms, ultrasounds, and scans. It can also include the results of tests conducted on bodily fluids, such as throat cultures, urinalysis, cholesterol levels, and blood work. The digital health record can also include immunization records documenting immunizations given for diseases, such as polio, measles, mumps, rubella, and the flu. The record can also include consent and authorization forms, such as copies of consents for admission, treatment, surgery, and release of information.

In certain embodiments, detailed reports and summaries, such as an operation report, a pathology report, and a discharge summary can also be included. The operation report can describe specific details related to surgeries performed and identify the surgeons and assistants performing these surgeries. The pathology report can describe tissue removed during an operation and the diagnosis determined from an analysis of the tissue sample. The discharge summary can provide a concise summary of the individual's hospital stay, including the reason for admission and release, significant findings, procedures performed, therapies provided, medications prescribed, the individual's response to treatments, and instructions for medications, activity, diet, and follow-up procedures or care.

It should be appreciated that system 5 is capable of interacting with any CHR 10 that supports health care interoperability standards, including, for example, HL7, ANSI X12, EN13606, HISA, DICOM, ISO 18308.

System 5 can include facility/physician records 20. Facility/physician records 20 can include a database of National Provider Identifier (“NPI”) numbers, and a database of health care facilities. Facility/physician/physician extender records 20 can also include a physician's, a physician extender's, or a facility's associated NPI identification number, name, location information, contact information, office hours, provider taxonomy details, credentials, accepted insurance information, provider ratings, and amenities.

HIPAA created an Administration Simplification Standard or National Plan & Provider Enumeration System (“NPPES”) that created unique NPI numbers for identifying and managing health care providers and facilities. The NPI is a 10-digit, intelligence-free numeric identifier associated with each health care provider or facility that provides care for Medicare and Medicaid patients. A database of NPI numbers is managed by Health and Human Services' (“HHS”) Centers for Medicare and Medicaid Services (“CMS”). HHS's CMS provide a database, updated monthly, that lists all providers and facilities registered to care for Medicare and Medicaid patients. The NPPES database can serve as a resource to identify health care providers and facilities within a geographic area.

Participating health care systems and facilities provide databases that list those practitioners who are on staff at a facility or facilities. These databases are collected and matched to the practitioner's NPI database information for confirmation of the physician's practice and the practice's associated biographical information.

Additionally, facility/physician/physician extender records 20 can include physician and facility ratings, collected from multiple sources, such as ANGIE'S LIST™, HEALTHGRADES.COM™, RATEMDS™, REVOLUTION HEALTH GROUP™, ZAGAT™, and users of system 5. Additionally, users of system 5 can rate a physician or facility, for example, based on a scale of 1-5, whereby 5 is the best rating and 1 is the worst rating. The ratings can include assessments of physicians and facilities on their cleanliness, beside manner, the helpfulness of office staff, whether the physician explained things clearly, whether the physician understood the patient's concerns, etc.

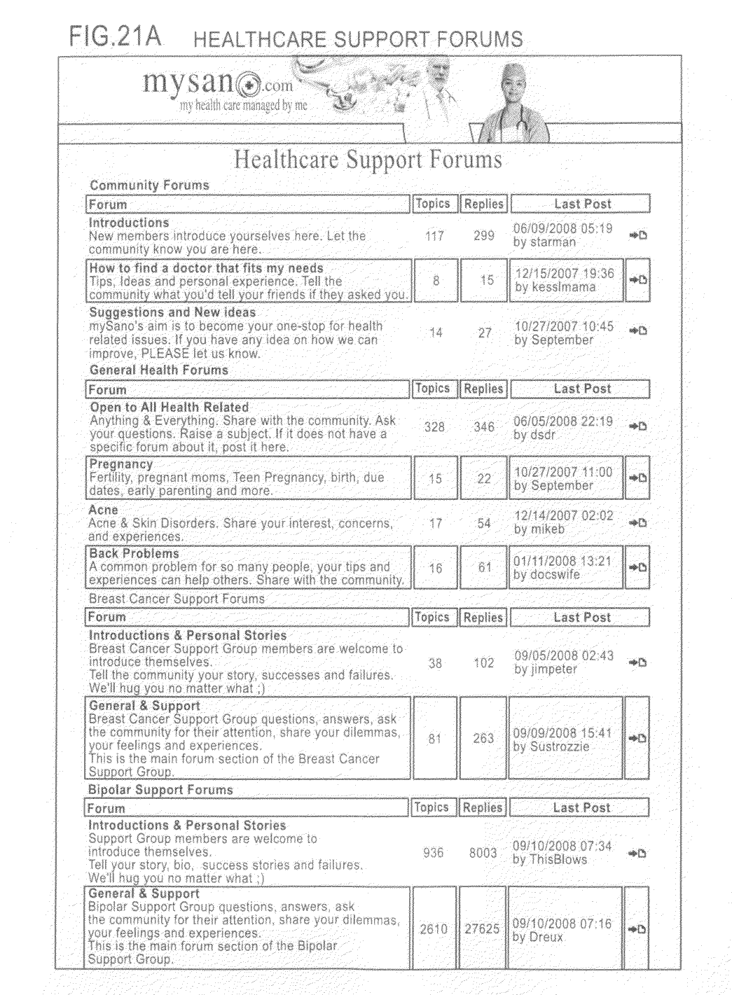

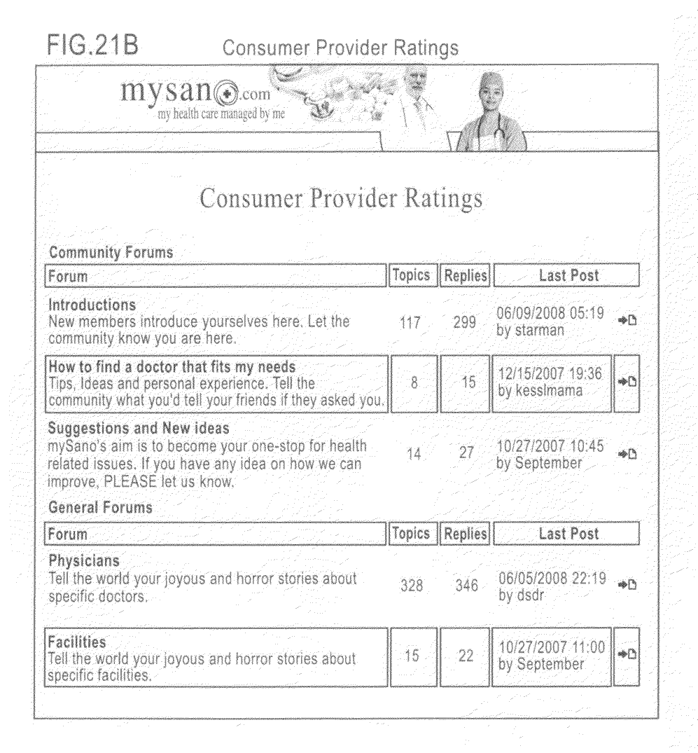

Physician, physician extender and facility ratings are provided on respective physician and facility information profile pages in the graphical user interface 150 discussed below. These ratings can be displayed in a FORUMS section, such as a healthcare support forums, within the detailed view page of a respective physician's or facility's health information profile pages as discussed below. The healthcare support forums, as illustrated in FIGS. 21A and 21B, can include healthcare diagnosis, health condition related chat sessions utilized by registered consumers

Additionally, system 5 can include insurance provider records 30. Insurance provider records 30 can include data on available health plans organized by geographic region or a specific state. Insurance provider records 30 can also include insurance provider names, addresses, contact information, insurance offerings, and promotional items. Additionally, insurance provider records 30 can also include a list of facilities that accept their specific insurance plans. Insurance provider records 30 can be used to pre-populate the insurance drop-down menus on the consumer view of the graphical user interface 150 and the physician registration area on the home page view of the graphical user interface 150 discussed below. Insurance provider records 30 can be periodically or continually updated, permitting an adaptive map of insurance providers to be updated and organized by geographic region or specific state as more data is loaded into system 5 by a system administrator. Private and government insurance entities can also provide data resources to the system administrator for updating insurance provider records 30.

Furthermore, system 5 can include health care benefits and administrative records 40. Health care benefits and administrative records 40 can include benefit administration names, addresses, contact information, and associated products and services. Health care benefits can include links to financial service companies that hold consumer health savings accounts (“HSA”) information. In 2003, Congress passed the Medicare Reform Act that created tax-exempt individual HSAs to be used exclusively for health care expenditures, creating another resource to assist an individual in managing his own health care needs, information, and costs. Administrative records can include data provided from outside agencies that coordinate health care benefits for employers.

System 5 can include non-U.S. multi-disciplinary data 50. Non-U.S. multi-disciplinary data 50 can include consumer health records, facility/physician/physician extender records, insurance provider records, medical tourism demand and trends, health care administration offerings, and health care benefits administration records, and their associated sub-components as discussed above, from non-U.S. sources. Accordingly, system 5 provides an electronic marketplace for an individual to access and manage his health care in the U.S. and abroad. For example, system 5 can function as a one-stop shop for medical tourism-related health care needs ranging from hip surgery to medical rejuvenation service.

Furthermore, system 5 can include a health care knowledge database 60. The health care knowledge database 60 can display RSS feeds from common health care information sources, whereby the feeds can include, for example, blog entries, news headlines, podcasts about health care content, health tips, health alerts, information about conferences, webinars, workshops, events and conventions, and information about leading health care innovations. The health care knowledge database 60 can also provide links to external databases from informational sources, such as WEBMD.COM™, WIKIPEDIA™, and REVOLUTIONHEALTH.COM™. Additionally, system 5 can alert, remind, educate the consumer, physician, physician extender, and facility of events that may impact each of their profiles.

System 5 can include a plurality of physician extenders 70, consumers 80, facility administrators 90, and physicians 100, who are both sources of health care information and participants in the health care system.

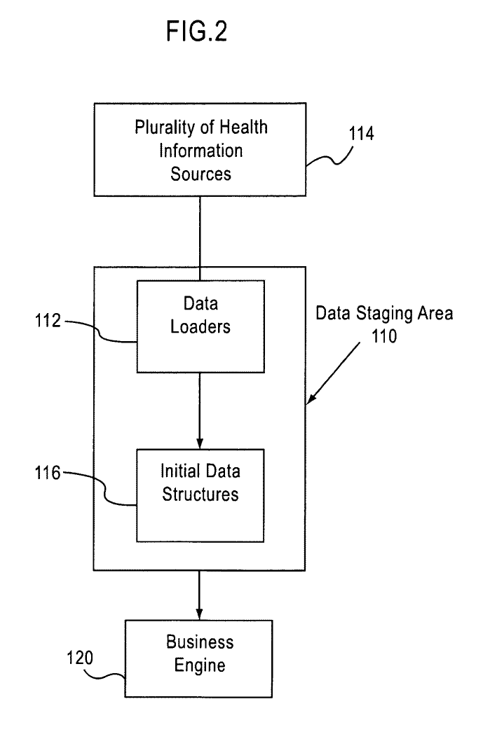

Additionally, system 5 can include a data staging area 110 for compiling health information, as further illustrated in FIG. 2, in accordance with an embodiment of the present invention. The data staging area 110 can receive health information from consumer health records 10, facility/physician/physician extender records 20, insurance provider records 30, healthcare benefits administration records 40, non-U.S. multi-disciplinary data 50, healthcare knowledge database 60, physician extenders 70, consumers 80, facility administrators 90, and physicians 100. All of the health information can be received by and stored in the data staging area 110 initially as raw data. Data staging area 110 can clean, collate and catalog the raw health information data to facilitate pre-population of data into core database 140, and subsequently into the consumer, physician, and facility views of graphical user interface 150. Accordingly, data staging area 110 facilitates a streamlined process 170 of registering a physician, physician extender, consumer, and facility through the graphical user interface 150.

Data staging area 110 can include data loaders 112, whereby the data loaders are configured to pump in the health information from the plurality of health information sources 114, placing the raw data of health information into a plurality of initial data structures 116.

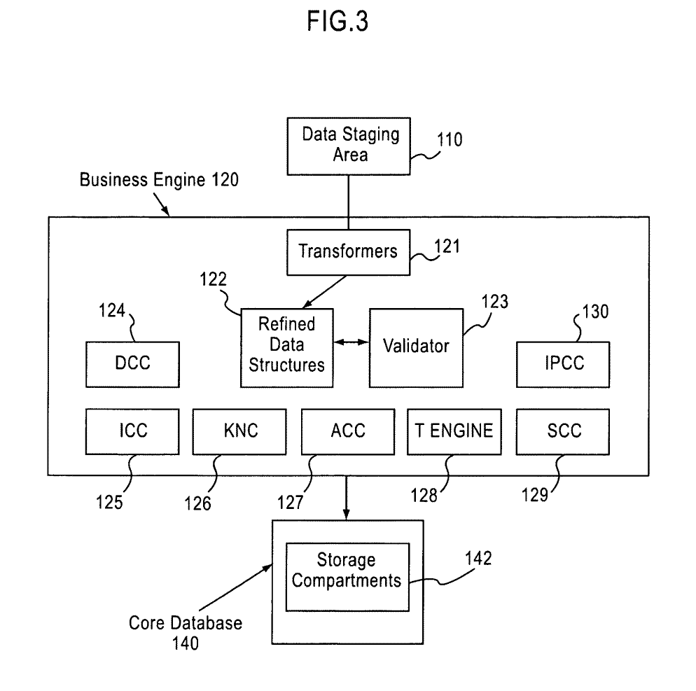

System 5 can further include business engine 120 for processing health information for a web-based application, as further illustrated in FIG. 3, in accordance with an embodiment of the present invention. Business engine 120 can include a plurality of transformers 121 that transform the initial raw data of health information from the plurality of initial data structures 114 into refined health information data stored in a plurality of refined data structures 122 in business engine 120. Business engine 120 can process the transformed health information, refining the transformed health information into data to be validated and tested for accuracy by validator 123, and subsequently loaded into core database 140. Validation can also utilize valid email addresses, NPI Number, and the health care provider's or facility's bankcard for leveraging base and premium services to be discussed below. From core database 140, users of the graphical user interface 150 can view, update, and publish health care information associated with the consumer, the physician, physician extender, and the health care facility.

Business engine 120 can further include a plurality of sub-components, such as a data control center 124, an information control center 125, a knowledge delivery center 126, an alert control center 127, a transformation engine 128, a security control engine 129, and an intellectual property control center 130.

Collectively these sub-components can function to identify, define, and link to credible information and complete health care raw data sources. For example, these sub-components can identify credible and reliable data sources. These sub-components can define critical data elements, such as an attribute name, value range, source, update frequency, last update, last update by, and update trail. Further, these sub-components can execute a data sharing agreement with a data source provider by defining source data update frequency, source data availability alerts, source data usage descriptions, source data usage costs. These sub-components can also define and implement import mechanisms from these raw data sources.

Data control center 124 can facilitate health information data inflow from the plurality of health information sources 114, such as a NPI database or any National Healthcare Registry database, CMS taxonomy data feed, insurance feeds, medical knowledge base data feeds, facility-related data feeds, and health care benefits administration feeds. The inflow of data can be received in raw data feeds in their native format, such as *.viz, *.xml, *.csv, *.xls, *.doc, *.pdf, and flat files.

Information control center 125 can consolidate the health information data from the plurality of health information sources 114, and consolidates RSS feeds from live medical news sources. Information control center 125 can also collate profile specific custom feeds for consumers, physicians, physician extenders, and facilities including physician grades/ratings and regionalized health-related feeds. Further, information control center 125 can also consolidate financial services-specific consumer, physician, physician extenders, and facility feeds.

Knowledge delivery center 126 can deliver profile-based recommendations and analytics functions to consumers, physicians, physician extenders, and facilities. Further, knowledge delivery center 126 can provide region-based and financial services-based analytics functions.

Alert control center 127 can provide alert notification to meet physician and physician extender profile needs, consumer profile needs, and facility profile needs. Alert control center 127 can also manage time-based scheduling events, the needs of data control center 124, including, for example, availability of new data feeds, availability of new knowledge feeds, and data backups. Alert control center 127 can also manage the needs of information control center 125 and knowledge delivery center 126.

Transformation engine 128 can transform and load the validated health information data into core database 140.

Security control center 129 can monitor and manage user registration security and security audits for data access, uploads, and updates.

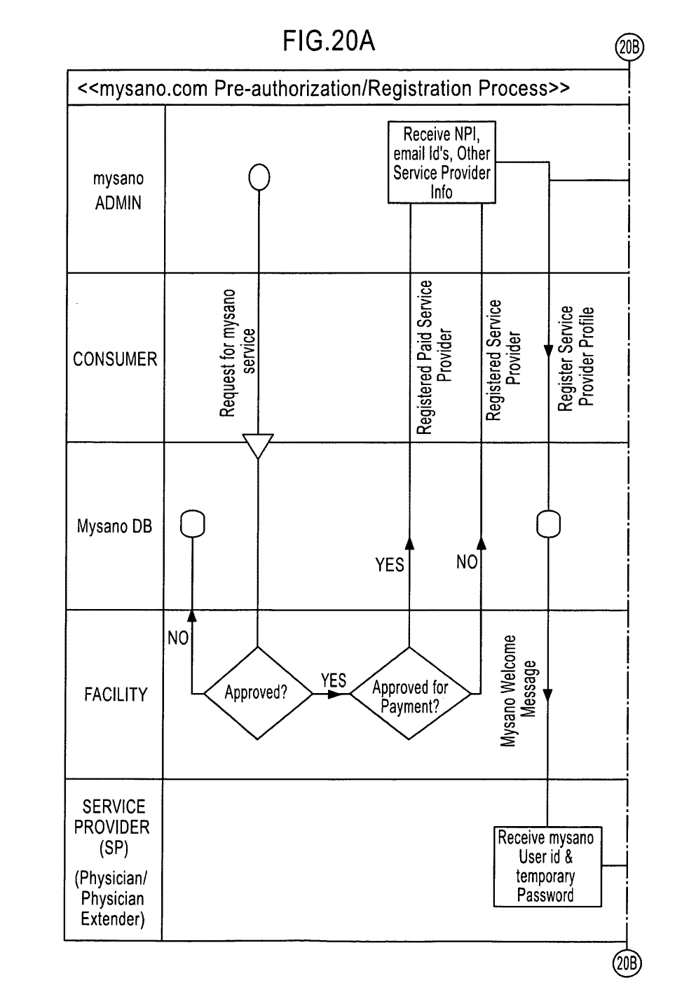

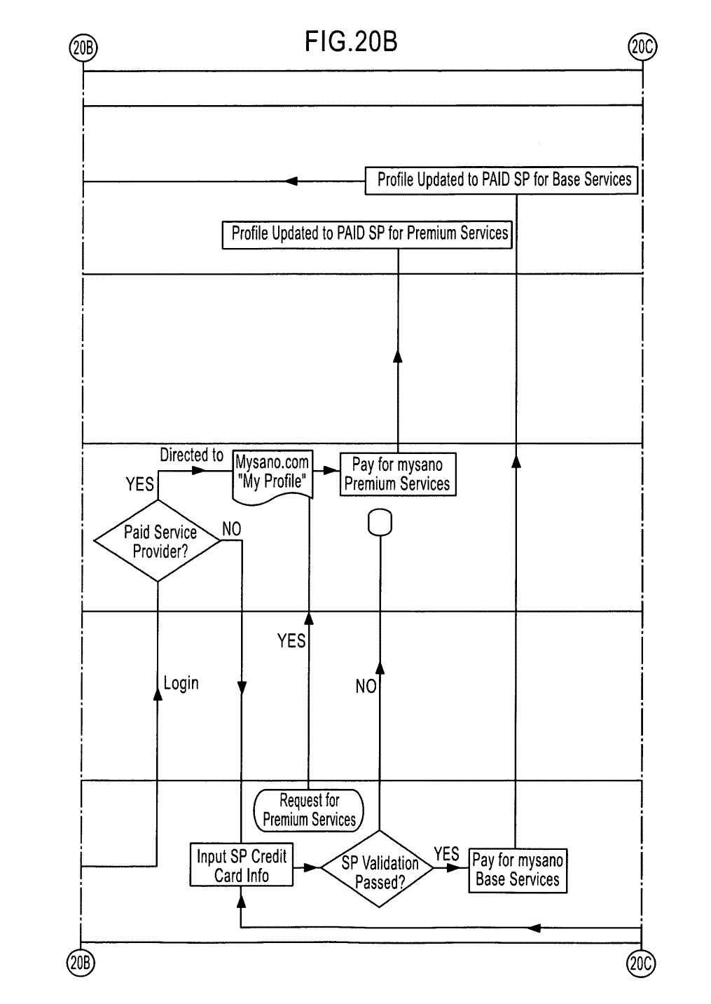

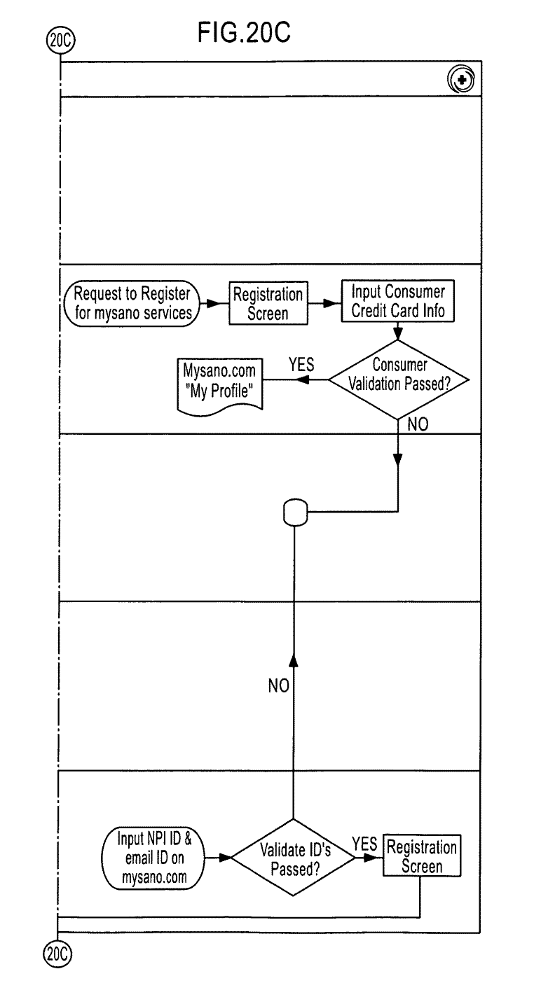

Intellectual property control center 130 can define, document, and track activity for the web-based application, such as the core database, the data transformation process and logic, the productivity tools 160, the user profile registration process, as generally illustrated in FIGS. 20A, 20B, and 20C, and all functional modules of system 5.

Storage components 142 of core database 140 can be configured to store the refined health information data, whereby the health information data has been validated and tested for accuracy by validator 123 in business engine 120. Core database 140 can also store user registration and security access information based on physician/physician extender, consumer, and facility profiles. Updates to core database 140 can be triggered by changes to data staging area 110 in response to newly received health information from the plurality of health information sources 114. Updates to core database 140 subsequently can initiate the transformation of additional raw data of health information from the plurality of initial data structures 116 in data staging area 110, to the plurality of refined data structures 122 stored within business engine 120. Subsequently, validation and accuracy testing can be performed by validator 123 on the refined health information data to assure data accuracy and authentication.

In one embodiment of the present invention, a consumer can access the web-based application, whereby system 5 can provide the user of graphical user interface 150 with the ability to access and manage his personal health records and to locate physicians/physician extender and/or health care facilities within the user's localized area using a zip code. Furthermore, the consumer can determine whether physicians and facilities are accepting new patients and whether the consumer's medical insurance is accepted. If both of these criteria are satisfied, graphical user interface 150 can allow the consumer to schedule an appointment for health care services.

In another embodiment of the present invention, a physician can access the web-based application, whereby system 5 can provide the healthcare provider with the ability to monitor changes or updates to the physician's or the physician extender's profile. The healthcare provider's profile can be changed or updated via information received from the plurality of health information sources 114 described above. System 5 can include an alert subsystem configured to alert the healthcare provider of these changes. System 5 can also allow the healthcare provider to update his own profile information. This information can be presented to the consumer in a uniform and easily understandable way in the consumer's graphical user interface.

In another embodiment of the present invention, the graphical user interface 150 of system 5 can provide a facility with the ability to create and update its profile information, which is stored as raw data of health information in data staging area 110. This information can be presented to the consumer in a uniform and easily understandable way in the consumer's graphical user interface. The graphical user interface 150 of system 5 can also provide similar features to a physician extender for creating and updating his profile information, which is stored as raw data of health information in data staging area 110. This information can be presented to the consumer in a uniform and easily understandable way in the consumer's graphical user interface. A physician extender can also be referred to as a “mid-level provider,” and commonly known as a physician's assistant, nurse practitioner, mid-wife, or other allied health professionals.

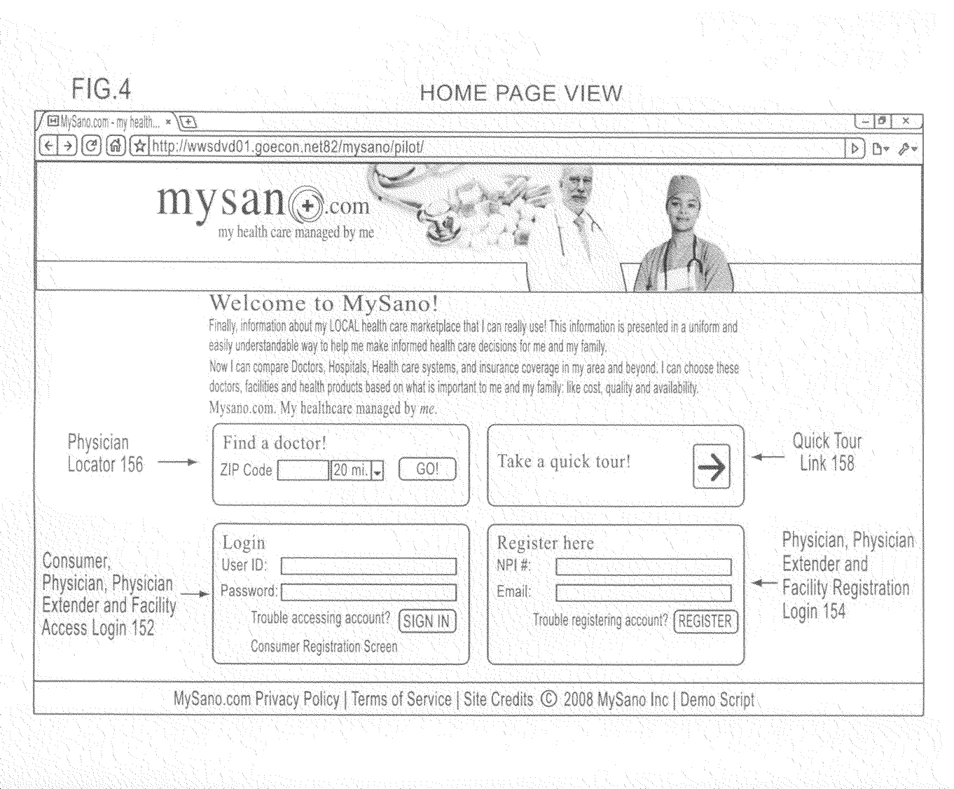

FIG. 4 is a home page view of a graphical user interface, in accordance with an embodiment of the present invention. Graphical user interface 150 can provide health care-related features for four types of users: a consumer, a physician, a physician extender, and a health care facility administrator. The home page view of graphical user interface 150 can include a consumer access login 152, a physician, a physician extender and facility access login 154, a physician locator 156, and a quick tour link 158.

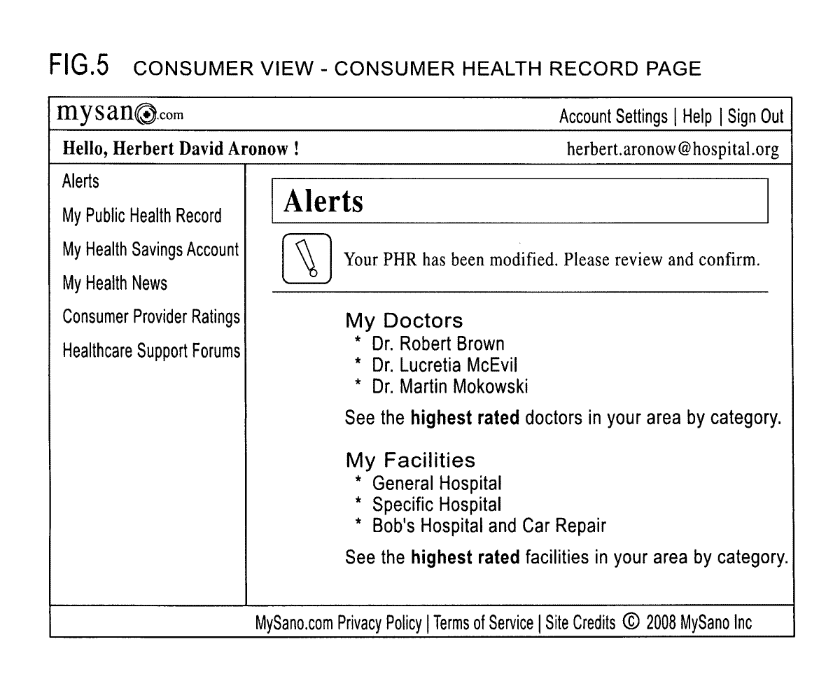

FIG. 5 is a consumer view—consumer health record page of the graphical user interface, in accordance with an embodiment of the present invention. Consumer access login 152 can provide a consumer with access to his personal health information and health information associated with a database of physicians and health care facilities. A consumer can access the consumer view of the graphical user interface 150 by entering his “username” and “password” or through other security measures as may be appropriate. Such security measures may include security questions, retina scans, fingerprint scans, etc.

Upon entry into the consumer view of the graphical user interface, the user will be able to view his entire personal health information, including any medical information described above for CHRs, applicable to the user. The consumer can also be provided with a link to their personal financial services/health savings account.

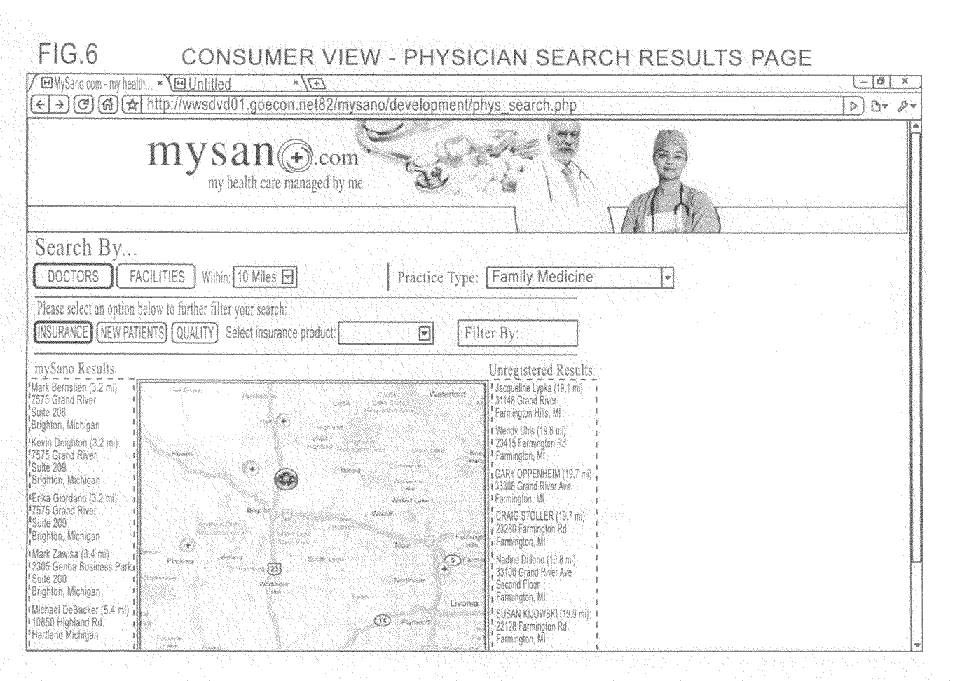

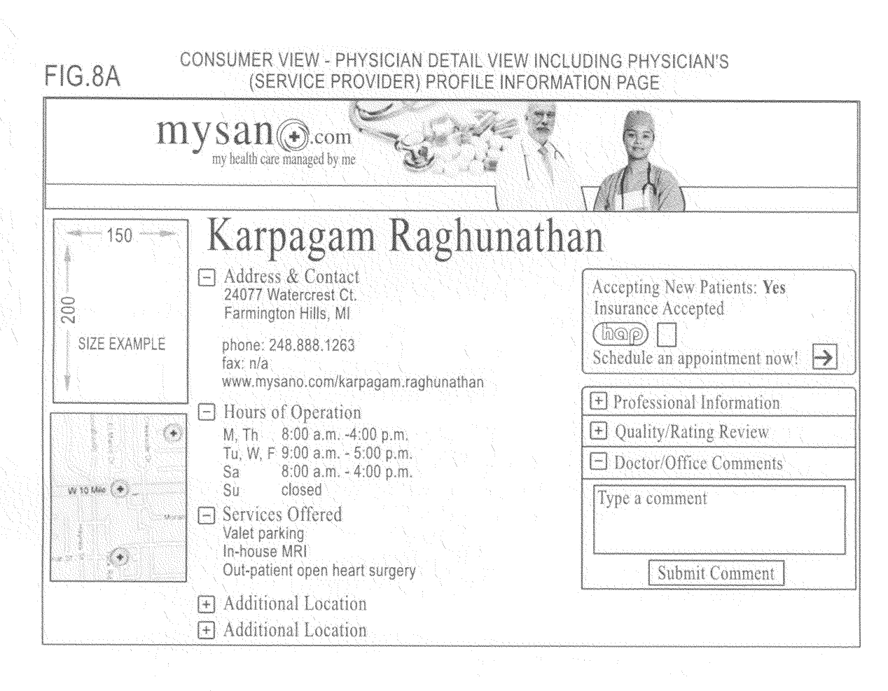

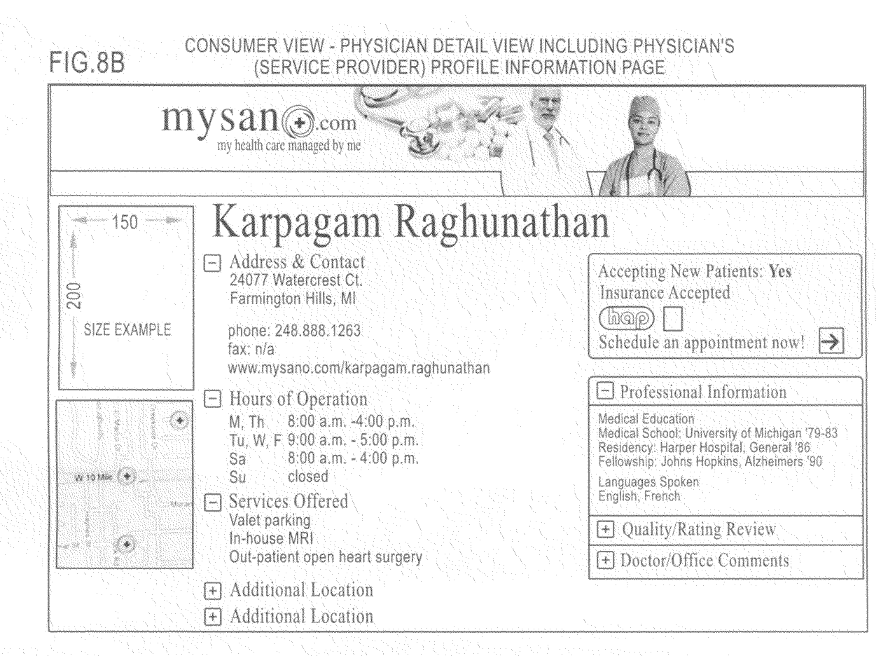

FIG. 6 is a consumer view—physician search results page of the graphical user interface, in accordance with an embodiment of the present invention. The consumer view—physician search results page may include search parameters of doctor type, health insurance accepted, whether the physician, physician extender and/or facility is accepting new patients, and quality rating of the physician or facility. Physician locator 156 can provide a consumer with the ability to search for a physician or health care facility localized by zip code. As an extension the physician locator can also provide a consumer with the ability to search for a physician by first name, last name, city and state. As illustrated in FIG. 6, the search for a physician can further be filtered by the following criteria: within a prescribed mileage distance, physician type, type of insurance accepted, whether the physician is taking new patients, and quality measurements. The physician search results page can include a map of the local area where the physician's practice is located. The map can be any online map, such as a MAPQUEST™ or GOOGLE™ map, and can show the selected mileage radius view as dictated by the user, i.e. within a selected mileage radius to the zip code entered by the user. A list of physicians can also be provided, ordered by distance from the zip code. If a consumer clicks on the link for the physician, a detailed view, as illustrated in FIGS. 8A and 8B, is provided. Registered health care providers and facilities can be distinguished from non-registered entities as their information will be more complete and include health insurance participation information, etc.

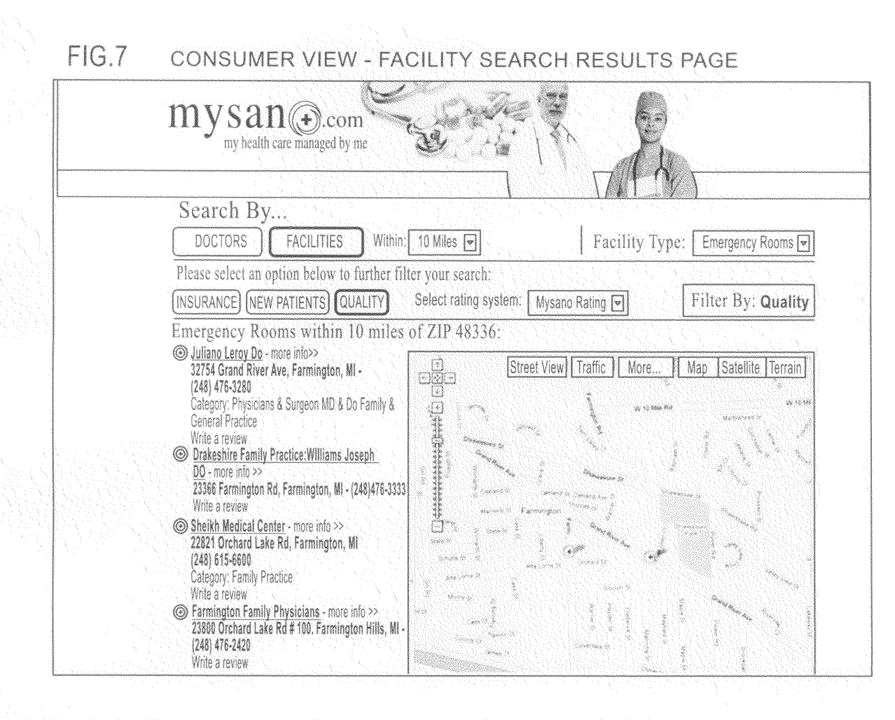

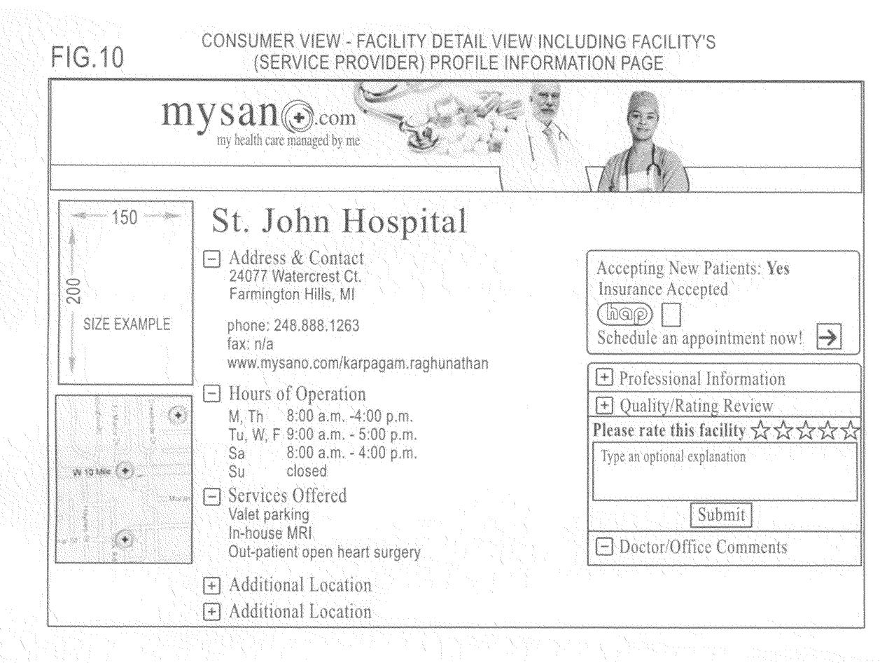

FIG. 7 is a consumer view—facility search results page of the graphical user interface, in accordance with an embodiment of the present invention. The consumer view—facility search results page may include search parameters of doctor type, health insurance accepted, whether the physician, physician extender, and/or facility is accepting new patients, and quality rating of the physician, physician extender, or facility. Physician locator 156 can also provide a consumer with the ability to search for a health care facility localized by zip code. Similarly to the physician search results page, the search for a facility can further be filtered by the following criteria: within a prescribed mileage distance, facility type, type of insurance accepted, whether the facility is taking new patients, and quality measurements. The facility search results page can include a map of the local area where the facility is located. The map can be any online map, such as a MAPQUEST™ or GOOGLE™ map, and can show the selected mileage radius view as dictated by the user, i.e. within a selected mileage radius to the zip code entered by the user. A list of facilities can also be provided, ordered by distance from the zip code. If a consumer clicks on the link for the facility, a detailed view, as illustrated in FIG. 10, is provided. Consumer health information regarding the facility can be displayed in a uniform and easily understandable way very similar to the physician detail page discussed above. Included facility attributes, however, will differ slightly from the attributes provided on the physician detail page.

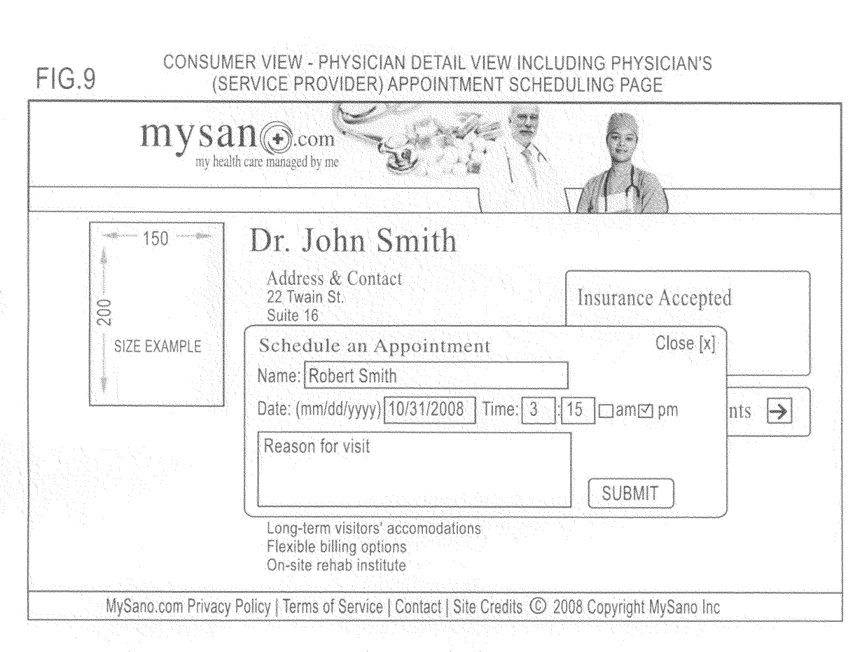

FIGS. 8A and 8B are consumer view—physician detail view including physician's (service provider) profile information pages of the graphical user interface, in accordance with an embodiment of the present invention. The detailed view of the physician's profile information can show an image of the provider, a map of the physician's location, the physician's contact information, hours of operation, services offered, insurance accepted, grade, and indicates whether the physician is accepting new patients. If the physician is accepting new patients, the consumer can schedule an appointment using the graphical user interface, as illustrated in FIG. 9.

FIG. 9 is a consumer view—physician detail view including physician's (service provider) appointment scheduling page of the graphical user interface, in accordance with an embodiment of the present invention. If the physician is accepting new patients, the consumer can schedule an appointment with the physician, designating a preferred date, time, and reason for the medical visit.

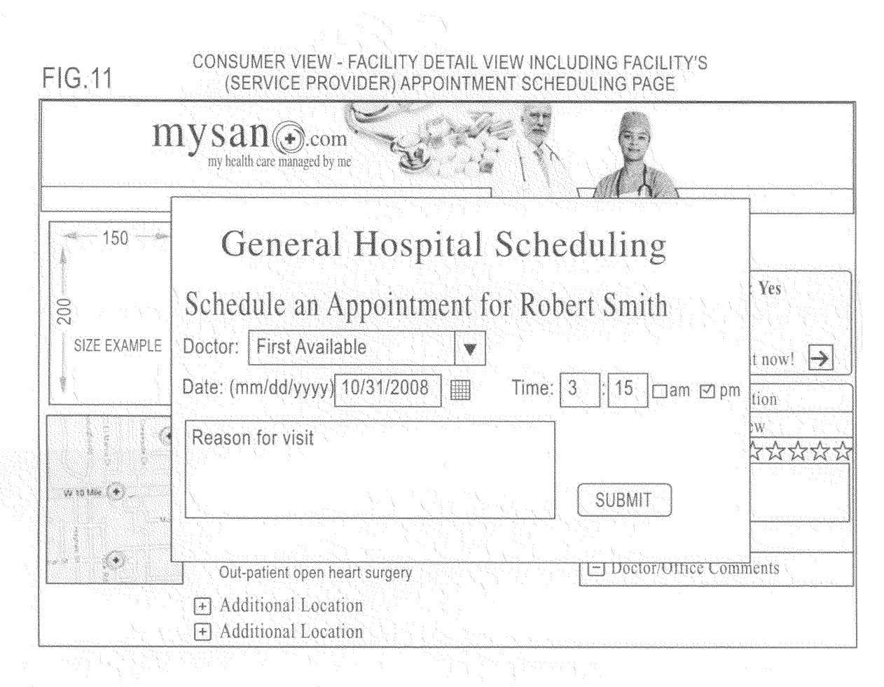

FIG. 10 is a consumer view—facility detail view including facility's (service provider) profile information page of the graphical user interface, in accordance with an embodiment of the present invention. The detailed view of the facility's profile information can show an image of the facility, a map of the facility's location, and list the facility's contact information, hours of operation, services offered, affiliated physicians and health care providers, insurance accepted, grade, affliated/associated facilities list, and indicates whether the facility is accepting new patients. It also can include links to the facility's own web-site, depending on the type of care sought by the consumer. If the facility is accepting new patients, the consumer can schedule an appointment using the graphical user interface, as illustrated in FIG. 11.

FIG. 11 is a consumer view—facility detail view including facility's (service provider) appointment scheduling page of the graphical user interface, in accordance with an embodiment of the present invention. If the facility is accepting new patients, the consumer can schedule an appointment with the facility, designating a preferred date, time, and reason for the medical visit.

Physician and facility access login 154 provides a physician and facility with the ability to enter the physician view and facility view, respectively, of the graphical user interface 150. Physicians and facilities can register with and access the graphical user interface 150 by entering their associated NPI number and a valid email address. In the physician view and facility view, a physician and a facility can update information associated with its practice, background, offered services, accepted insurance, new patient availability, primary service location, affliated/associated secondary locations and available amenities. Validation of data can be further accomplished by using bank card registration. As previously noted above, the physician view and facility view can be updated periodically with new health information data received from the plurality of health information sources.

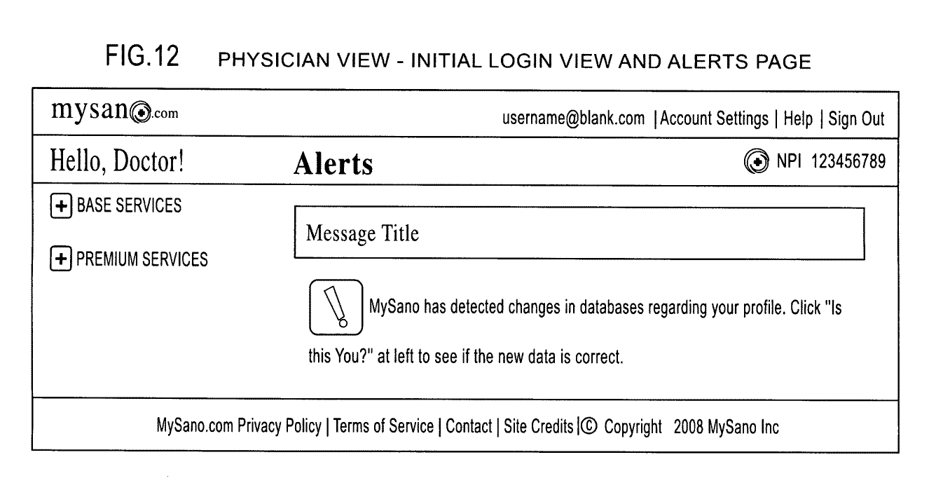

FIG. 12 is a physician view—initial login view and alerts page of the graphical user interface, in accordance with an embodiment of the present invention. Once system 5 confirms the physician's access, graphical user interface 150 can open an alerts page alerting the physician to any detected changes in his profile from any of the plurality of health information sources. The alerts page can permit the physician to confirm any changes that have been made to his profile. The alerts page can include the physician's NPI number in the upper-right hand corner to confirm the identity of the physician. The alerts page can also include RSS feeds and notify the physician of drug recalls and other relevant regional or national health care notifications. The alerts page can list “premium” services on the left-hand side of the alert page. These “premium” services can depend on the health care provider's level of participation. This can include appointment scheduling, analytics, and additional health care marketplace information.

The data screens menu can be located on the left-hand side of the alerts page. The data screens menu can include “base” services, such as confirmation of the provider's consumer health information. The “Is This You?” link can direct the physician to a physician identity page.

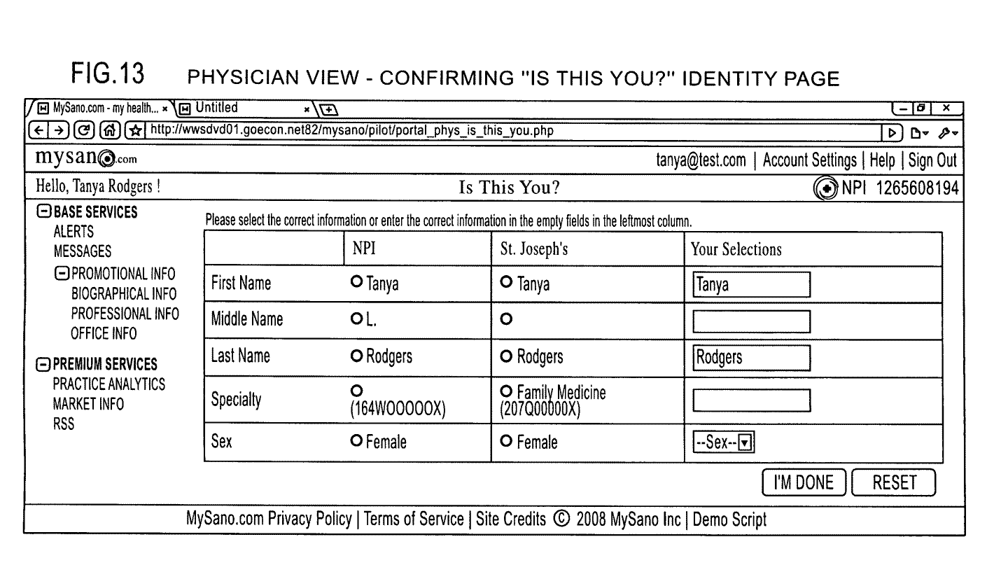

FIG. 13 is a physician view—confirming “Is This You?” identity page of the graphical user interface, in accordance with an embodiment of the present invention. The physician identity page can confirm the physician's identity based on his NPI number, a list of physicians stored in the NPI database, previously discussed above, and a comparative database of information from health care facilities, as available. The physician can modify this information by selecting a pre-populated field, manually entering the information, or selecting the information from a drop-down menu. The physician can then choose to save the information as a draft (“Save as Draft”), save the information (“Save”), or reset the screen (“Reset”). The physician can then be subsequently directed to a confirmation page.

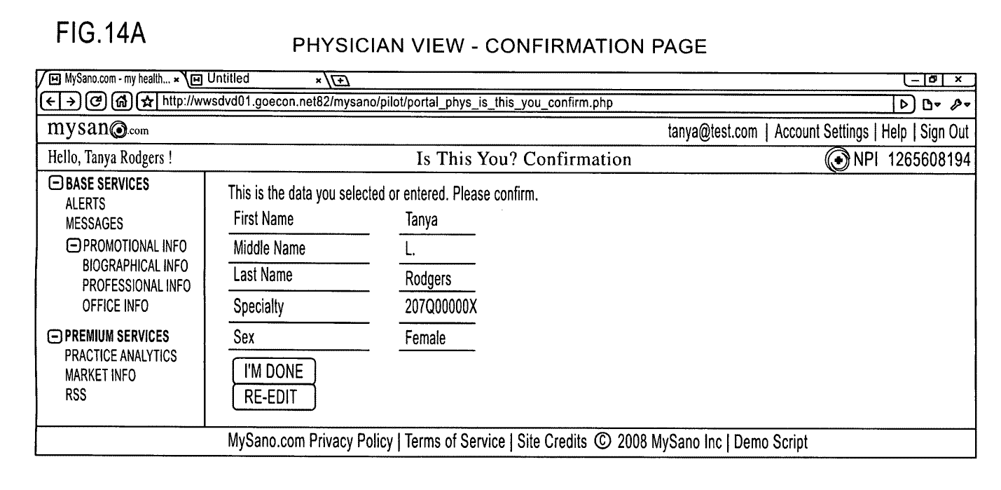

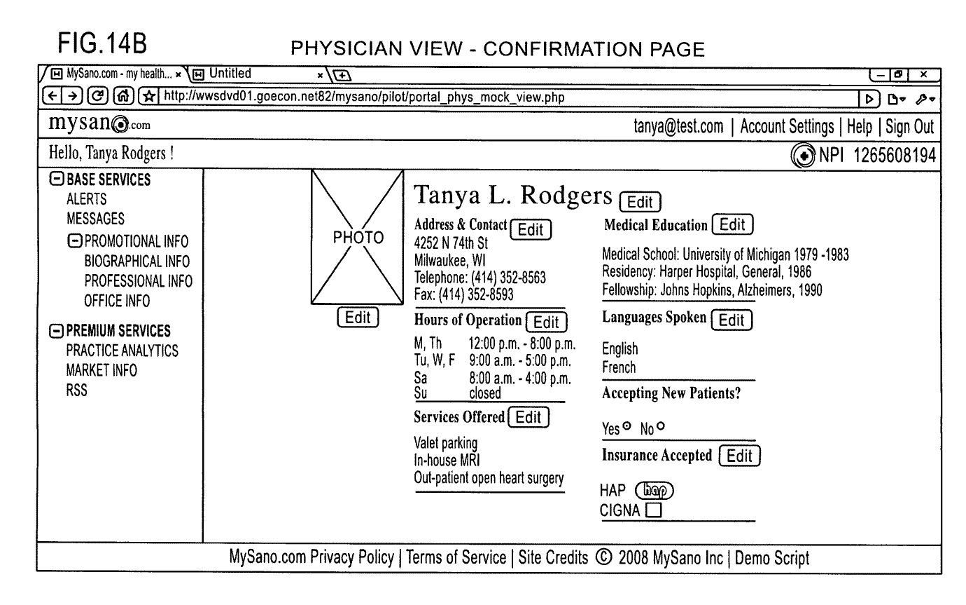

FIGS. 14A and 14B are physician view—confirmation pages of the graphical user interface, in accordance with an embodiment of the present invention. The confirmation page can permit the physician to confirm the entered identity information or re-edit the identity information. The physician can then be subsequently directed to a biographical information page.

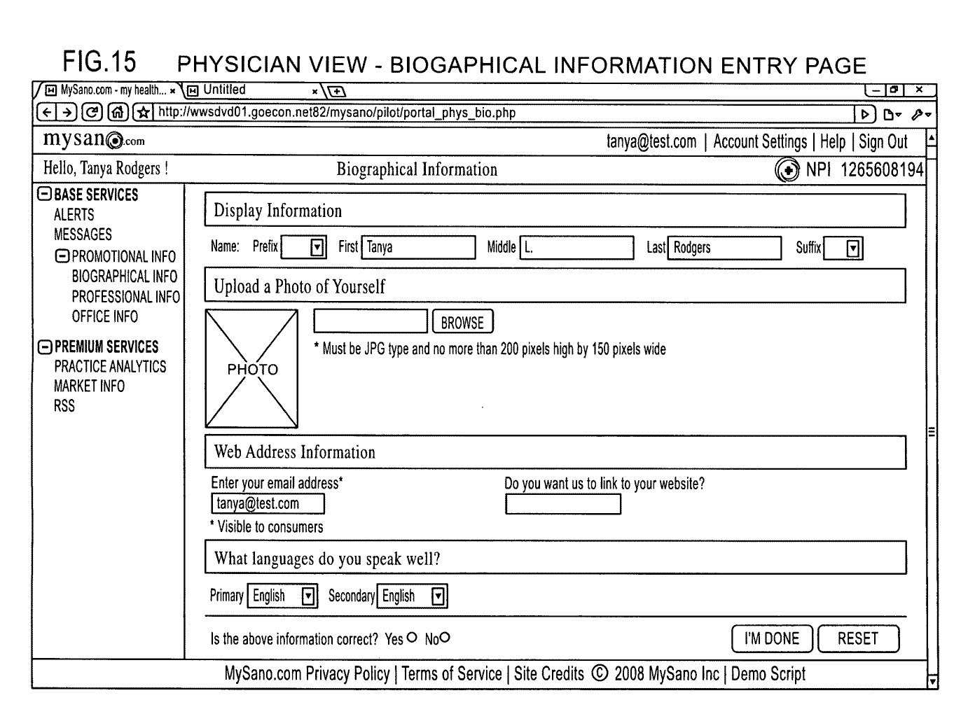

FIG. 15 is a physician view—biographical information entry page of the graphical user interface, in accordance with an embodiment of the present invention. The biographical information page can permit the physician to enter biographical information, including gender, name, a photo, web address information, and primary and second languages spoken. The physician can then be subsequently directed to a professional information page.

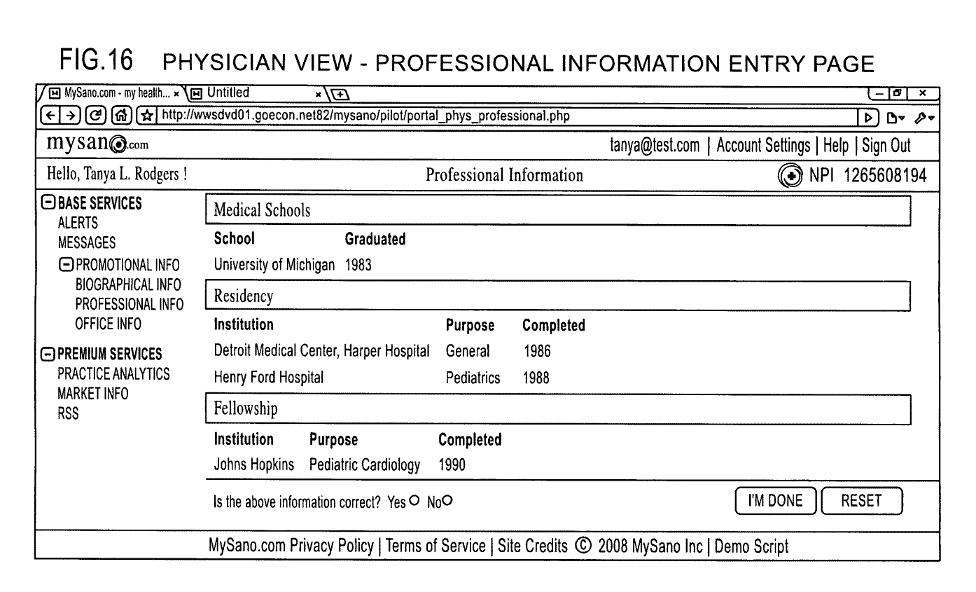

FIG. 16 is a physician view—professional information entry page of the graphical user interface, in accordance with an embodiment of the present invention. The professional information page can permit the physician to enter professional information, including medical school attended, details related to the physician's residency, and details related to the physician's fellowships. The physician can then be subsequently directed to an office information page.

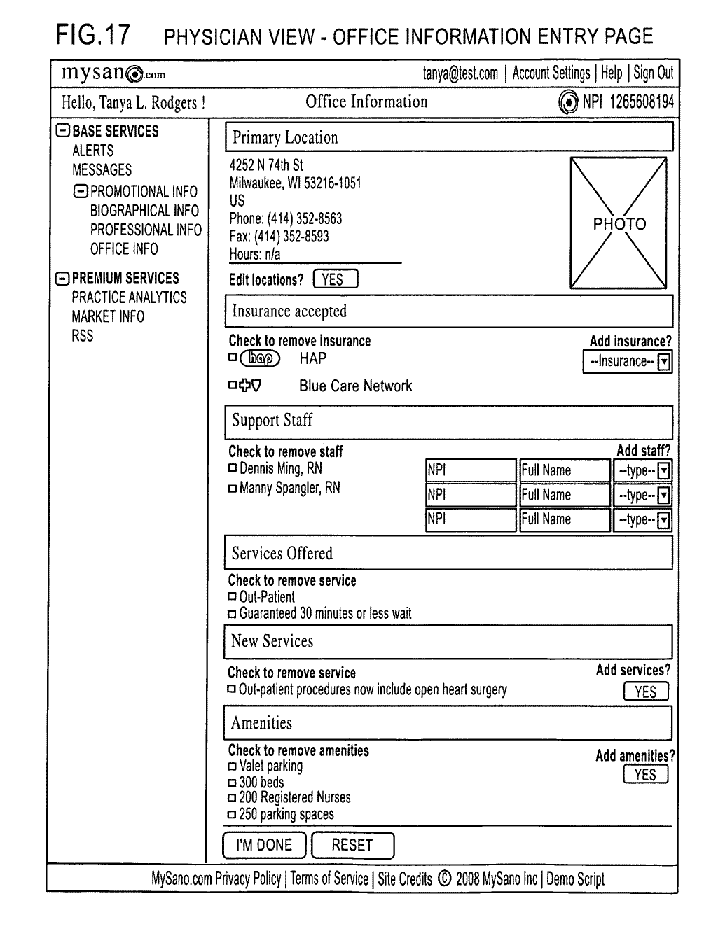

FIG. 17 is a physician view—office information entry page of the graphical user interface, in accordance with an embodiment of the present invention. The office information page can permit the physician to enter details about the physician's practice, including, for example, the practice's location, hours of operation, insurance accepted, support staff on location, services offered, new services offered, and amenities. The practice's location can include a map of the local area where the physician's practice is located. The support staff on location can include advanced practice nurses and physician assistants. The services or new services offered can include, for example, valet parking, number of beds, number of registered nurses, number of parking spaces. Additionally, the physician can add additional facilities he/she is associated with along with all relevant facility information as listed above.

All of the information entered about the physician, as illustrated in FIGS. 12-17, can be confirmed by the physician or his representative, providing profile data feeds that are transmitted into data staging area 110 and processed through business engine 120 for use by the consumer.

As previously noted above, the physician view of the graphical user interface 150 can also be updated periodically with new health information data received from the plurality of health information sources 114.

Quick tour link 158 can provide a quick tour of the features of the graphical user interface 150.

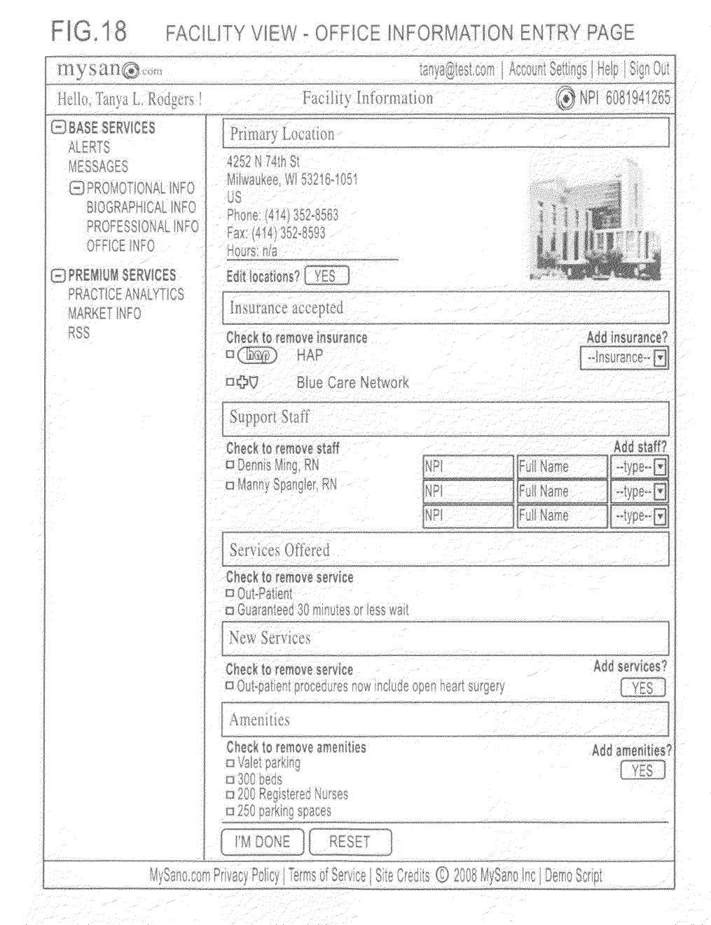

FIG. 18 is a facility view—office information entry page of the graphical user interface, in accordance with an embodiment of the present invention. The facility view page can permit the facility to enter details about the facility, including, for example, the facility's location, hours of operation, insurance accepted, support staff on location, services offered, new services offered, and amenities. The facility's location can include a map of the local area where the facility is located. The support staff on location can include advanced practice nurses and physician assistants. The services or new services offered can include, for example, valet parking, number of beds, number of registered nurses, number of parking spaces. Additionally, the facility can permit the facility administrator to add affiliated facilities it is associated with along with all relevant affiliated facility information as listed above

All of the information entered about the facility, as illustrated in FIG. 18, can be confirmed by the facility or its representative, providing profile data feeds that are transmitted into data staging area 110 and processed through business engine 120 for use by the consumer.

As previously noted above, the facility view of the graphical user interface 150 can also be updated periodically with new health information data received from the plurality of health information sources 114.

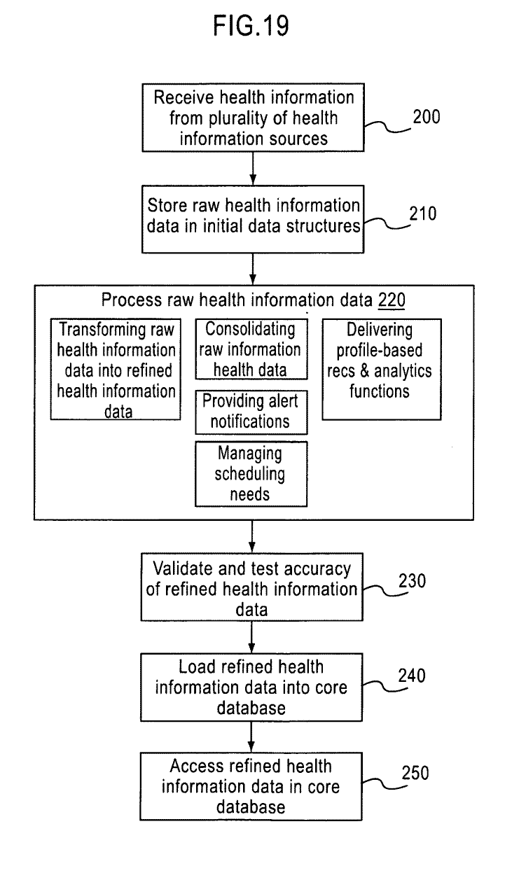

FIG. 19 is an example of a health information processing method, in accordance with an embodiment of the present invention. At step 200, a data staging area 110 can receive health information from a plurality of health information sources 114. At step 210, data staging area 110 can store the raw health information data in a plurality of initial data structures 116. At step 220, a business engine 120 can process the raw health information data by transforming the raw health information data stored in the plurality of initial data structures 116 into refined health information data stored within a plurality of refined data structures 122 in business engine 120. The transformation of step 220 can include refining the raw health information data into data for validation and accuracy testing. At step 230, validator 123 can validate and test the accuracy of the refined health information data. At step 240, business engine 220 can load the refined health information data into core database 140. At step 250, consumers, physicians, and facilities can access the refined health information stored in core database 140 through a web-based portal having graphical user interface 150.

Using graphical user interface 150, a consumer can view and manage his personal health records, locate a physician or health care facility for health care services in a specific geographical area, for example, designating a user selected zip code, and schedule an appointment with the physician or health care facility if the physician or health care facility is accepting new patients and their insurance. Graphical user interface 150 can allow the consumer to view physician profile information and facility profile information in a uniform and easily understandable way assisting the consumer with determining whether to select a specific physician or health care facility to provide the consumer with health care services.

Processing the raw health information data can further include consolidating the health information received from the plurality of health information sources 114, whereby the plurality of health information sources can include, for example, information from consumer health records 10, facility/physician records 20, insurance provider records 30, healthcare benefits administration records 40, non-U.S. multi-disciplinary data 50, a healthcare knowledge database 60, physician extenders 70, consumers 80, facility administrators 90, and physicians 100. Health information sources can also include information from a NPI database, a CMS taxonomy data feed, insurance feeds, medical knowledge base data feeds, facility-related data feeds, and health care benefits administration feeds, and RSS feeds from live medical news sources.

Processing the raw health information data can further include delivering profile-based recommendations and analytics functions to consumers, physicians, physician extenders, and facilities, such as region-based and financial services-based analytics functions.

Processing the raw health information data can further include providing alert notifications to meet physician and physician extender profile needs, consumer profile needs, and facility profile needs. Further, processing the raw health information data can include managing time-based scheduling events, consumer reminders, pre-authorization processing, and the needs of data control center 124, including, for example, availability of new data feeds, availability of new knowledge feeds, and data backups.

The aforementioned features for providing analytics functions, schedule management, consumer reminders delivery, distribution of alert notifications, and the pre-authorization process are examples of productivity tools 160 provided by system 5.

The health information processing method can further include updating the core database 140 when receiving new raw health information data from the plurality of health information sources 114. Subsequently, the transforming, processing, validating, and loading of the health information data can be performed again.

FIGS. 20A, 20B, and 20C are flow diagrams for a user registration process, in accordance with an embodiment of embodiment of the present invention. The user registration process can include a service provider view and a consumer view.

The service provider view can include a registration and payment process for service provider (physician and physician extenders) and facility registration. First, the service provider or facility signs up for service with system 5. If the facility selects “base” services, the payment status for the service provider or facility profile can be designated as a “registered paid service provider or facility profile,” providing that service provider or facility with access to “base” services.

A system administrator can receive a list of service providers and/or facilities with corresponding NPI numbers, email addresses, and payment status. System 5 can then register the service provider or facility in core database 140 and create a temporary password for a respective service provider or facility. System 5 can then send a welcome message, such as a welcome email, notifying the service provider or facility of its user identification number and password. Subsequently, the service provider accesses system 5 using its user identification number and password.

Further, a service provider or facility can register and pay for services by inputting its NPI identification number and email address into graphical user interface 150. The NPI identification number can be validated against a NPI datastore in data staging area 110, the email address can be validated for authenticity, a service provider or facility registration page can be displayed along with password and security setup questions.

The service provider or facility can be requested to input his or her credit card information for validation and verification purposes. Once the service provider's or facility's identity is verified, the service provider or facility is directed to payment options for paying for use of the “base” services of system 5. System 5 can then send a message, such as a welcome email, notifying the service provider or facility of its status as a registered paid service provider or facility.

The service provider view can also display a service provider's or facility's profile. To access its profile, the service provider or facility can log into system 5 using graphical user interface 150 using the password and user identification number provided in the welcome message described above. The service provider's or facility's payment status can be checked. If the service provider or facility has a status as a registered “paid” service provider or facility profile, then the service provider or facility can be directed to its profile page, such as “my profile” page. If the service provider or facility has a status as a registered service provider or facility profile, e.g. the status shows that the service provider or facility has not yet paid, then it can be forwarded to follow the verification process described above.

The service provider or facility can navigate its “my profile” page by clicking on the “Is This You? Link to update its profile for which the information is entered into core database 140. Further, the service provider or facility can click on other links, such as biographical information, professional, and office information, to activate and update the information in these areas. All of the information updated by the service provider or facility can be viewed in real time by the consumer or user. The service provider or facility can also subscribe to “premium” services on the “my profile” page.

In the consumer view, a consumer can navigate the graphical user interface 150 to access system 5. The consumer can log into system 5 through graphical user interface 150 using the password and security setup questions provided. As previously described above for the service provider and facility, the consumer is requested to input his or her credit card information for validation and verification purposes. Once the consumer's identity is verified, the consumer is directed to its “my profile” page.

System 5 can then send a welcome message, such as a welcome email, notifying the consumer of its user identification number and password. Subsequently, the consumer accesses system 5 using its user identification number and password.

Reference to “base” services described above can refer to services permitting a consumer, service provider, or facility with the ability to view, input, and update their user/practice profile, providing this information in real time to end users of graphical user interface 150 of system 5.

Reference to “premium” services described above can refer to services including appointment scheduling, analytics, rating, alerts, RSS feeds, and appointment alerts to registered paid consumers, service providers, and facilities.

In accordance with an embodiment of the present invention, a computer program product embodied on a computer-readable medium can also be provided, whereby encoded instructions for performing at least the method described in FIG. 19, in accordance with an embodiment of the present invention, is provided.

The computer program product can be implemented in hardware, software, or a hybrid implementation. The computer program product can be composed of modules that are in operative communication with one another, and which are designed to pass information or instructions to a communications device, such as a user equipment, a personal computer, or handheld device, such as a mobile telephone or personal digital assistant, or their equivalents. The computer program product can be configured to operate on a general purpose computer or an application specific integrated circuit (ASIC).

The computer-readable medium can include, for example, a disk media computer memory, and other storage devices.

It is to be understood that in the embodiment of the present invention, the steps are performed in the sequence and manner as shown although the order of some steps and the like can be changed without departing from the spirit and scope of the present invention. In addition, the methods described in FIG. 19 can be repeated as many times as needed.

The many features of the invention are apparent from the detailed specification and, thus, it is intended by the appended claims to cover all such features of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents can be resorted to, falling within the scope of the invention.

We claim:

1. An apparatus, comprising:
a processor configured to receive raw health information data from a health information source, and to process the raw health information data by transforming the raw health information data into refined health information data;
a processing storage unit configured to store the refined health information data;
a validator configured to validate and test the refined health information data for accuracy; and
a transmitter configured transmit the refined health information data to a database storage unit for use by a graphical user interface to enable a user to access and manage health care needs of the user in a user selected geographical area.

2. The apparatus of claim 1, wherein the processor is further configured to receive raw health information data that has been cleaned, collated, and cataloged.

3. The apparatus of claim 1, wherein the processor is further configured to receive the raw health information data from the health information source comprising at least one of a consumer health record, a facility record, a physician record, an insurance provider record, a healthcare benefits administration record, a health care knowledge base, non-U.S. multi-disciplinary data, a physician, a consumer, a facility administrator, and a physician extender.

4. The apparatus of claim 1, wherein the processor comprises a transformer configured to transform the raw health information data into the refined health information data.

5. The apparatus of claim 1, wherein the processor is further configured to receive the raw health information data from a transmitter, wherein the transmitter comprises
a data loader configured to retrieve the raw health information data from the health information source, and
a transmitting storage unit configured to store the retrieved raw health information data.

6. The apparatus of claim 1, wherein the processor further comprises a data control center configured to facilitate the flow of raw health information data from the health information source through the receiver.

7. The apparatus of claim 6, wherein the data control center comprises at least one of a national provider identifier numbers database, a taxonomy data feed, an insurance feed, a medical knowledge base data feed, a facility-related data feed, and a health care benefits administration feed.

8. The apparatus of claim 1, wherein the processor further comprises an information control center configured to consolidate the raw health information data received from the health information source, and further configured to transmit profile specific custom feeds to the user, a physician, a physician extender, or a health care facility, and wherein the profile specific custom feeds comprise at least one of physician grades/ratings, regionalized health-related feeds, and financial services-specific consumer, physician, physician extender, or facility feeds.

9. The apparatus of claim 1, wherein the processor further comprises a knowledge delivery center configured to deliver at least one of profile-based recommendations, analytics functions, and region-based or financial services-based analytics functions to the user, a physician, a physician extender, or a facility.

10. The apparatus of claim 1, wherein the processor further comprises an alert control center configured to distribute an alert notification to a physician, a physician extender, or a facility in response to requirements of a physician profile, a physician extender profile, or a facility profile, respectively, and wherein the alert control center is further configured to manage time-based scheduling.

11. The apparatus of claim 1, wherein the processor further comprises a security control center configured to monitor and manage access of the user to a graphical user interface of the display.

12. The apparatus of claim 1, wherein the processor further comprises an intellectual property control center configured to monitor activity of the user to a graphical user interface of the display.

13. The apparatus of claim 1, wherein the database storage unit comprises a plurality of storage compartments, each configured to store the refined health information data for use by the graphical user interface.

14. The apparatus of claim 1, wherein the graphical user interface is configured to enable the user to access and manage his or her personal health record, locate a physician, a physician extender, or a health care facility based on the user selected geographical area, and schedule an appointment with the physician, the physician extender, or the health care facility when the physician, the physician extender, or the health care facility is accepting new patients.

15. The apparatus of claim 1, wherein the graphical user interface is configured to enable a physician, a physician extender, or a facility to update information of a physician profile, a physician extender profile, or a facility profile, respectively.

16. The apparatus of claim 1, wherein the user selected geographical area is based on at least one of a zip code, a physician first name, a physician last name, a physician city, or a physician state.

17. An apparatus, comprising:
processing means for receiving raw health information data from a health information source, and further for processing the raw health information data by transforming the raw health information data into refined health information data;
process storing means for storing the refined health information data;
validating means for validating and testing the refined health information data for accuracy; and
transmitting means for transmitting the refined health information data to a database storage unit for use by a graphical user interface to enable a user to access and manage health care needs of the user in a user selected geographical area.

18. A system, comprising:
a receiver configured to receive raw health information data from a health information source;
a processor configured to process the raw health information data by transforming the raw health information data into refined health information data;
a database storage unit configured to store the refined health information data; and
a display configured to display the refined health information data to enable a user to access and manage health care needs of the user in a user selected geographical area.

19. The system of claim 18, wherein the receiver is further configured to clean, collate, and catalog the received raw health information data.

20. The system of claim 18, wherein the receiver comprises a data loader configured to retrieve the raw health information data from the health information source.

21. The system of claim 20, wherein the receiver further comprises a receiving storage unit configured to store the retrieved raw health information data.

22. The system of claim 18, wherein the receiver is further configured to the receive raw health information data from the health information source comprising at least one of a consumer health record, a facility record, a physician record, an insurance provider record, a healthcare benefits administration record, a health care knowledge base, non-U.S. multi-disciplinary data, a physician, a consumer, a facility administrator, and a physician extender.

23. The system of claim 18, wherein the processor comprises a transformer configured to transform the raw health information data into the refined health information data.

24. The system of claim 18, wherein the processor comprises a processing storage unit configured to store the refined health information data.

25. The system of claim 18, wherein the processor comprises a validator configured to validate and test the refined health information data for accuracy.

26. The system of claim 18, wherein the processor comprises a data control center configured to facilitate the flow of raw health information data from the health information source through the receiver.

27. The system of claim 26, wherein the data control center comprises at least one of a national provider identifier numbers database, a taxonomy data feed, an insurance feed, a medical knowledge base data feed, a facility-related data feed, and a health care benefits administration feed.

28. The system of claim 18, wherein the processor comprises an information control center configured to consolidate the raw health information data received from the health information source, and further configured to collate profile specific custom feeds to the user, a physician, a physician extender, or a health care facility, and wherein the profile specific custom feeds comprise at least one of physician grades/ratings, regionalized health-related feeds, and financial services-specific consumer, physician, physician extender, or facility feeds.

29. The system of claim 18, wherein the processor comprises a knowledge delivery center configured to deliver at least one of profile-based recommendations, analytics functions, and region-based or financial services-based analytics functions to the user, a physician, a physician extender, or a facility.

30. The system of claim 18, wherein the processor comprises an alert control center configured to distribute an alert notification to a physician, a physician extender, or a facility in response to requirements of a physician profile, a physician extender profile, or a facility profile, respectively, and wherein the alert control center is further configured to manage time-based scheduling.

31. The system of claim 18, wherein the processor comprises a security control center configured to monitor and manage access of the user to a graphical user interface of the display.

32. The system of claim 18, wherein the processor comprises an intellectual property control center configured to monitor activity of the user to a graphical user interface of the display.

33. The system of claim 18, wherein the database storage unit comprises a plurality of storage compartments, each configured to store the refined health information data for use by a graphical user interface of the display.

34. The system of claim 18, wherein the display comprises a graphical user interface.

35. The system of claim 34, wherein the graphical user interface is configured to enable the user to access and manage his or her personal health record, locate a physician, a physician extender, or a health care facility based on the user selected geographical area, and schedule an appointment with the physician, physician extender, or health care facility when the physician, the physician extender, or the health care facility is accepting new patients.

36. The system of claim 34, wherein the graphical user interface is configured to enable a physician, a physician extender, or a facility to update information of a physician profile, a physician extender profile, or a facility profile, respectively.

37. The system of claim 18, wherein the user selected geographical area is based on at least one of a zip code, a physician first name, a physician last name, a physician city, or a physician state.

38. A method, comprising:
receiving raw health information data from a health information source;
processing the raw health information data by transforming the raw health information data into refined health information data;
storing the refined health information data;
validating and testing the refined health information data for accuracy; and
transmitting the refined health information data to a database storage unit for use by a graphical user interface to enable a user to access and manage health care needs of the user in a user selected geographical area.

39. The method of claim 38, wherein the receiving comprises receiving raw health information data that has been cleaned, collated, and cataloged.

40. The method of claim 38, wherein the receiving comprises receiving the raw health information data from the health information source comprising at least one of a consumer health record, a facility record, a physician record, an insurance provider record, a healthcare benefits administration record, a health care knowledge base, non-U.S. multi-disciplinary data, a physician, a consumer, a facility administrator, and a physician extender.

41. The method of claim 38, wherein receiving further comprises receiving the raw health information data from a transmitter, wherein the transmitter comprises
a data loader configured to retrieve the raw health information data from the health information source, and
a transmitting storage unit configured to store the retrieved raw health information data.

42. The method of claim 41, wherein the processing comprises facilitating the flow of the raw health information data from the health information source through the transmitter.

43. The method of claim 38, wherein the processing comprises consolidating the raw health information data received from the health information source, and further transmitting profile specific custom feeds to the user, a physician, a physician extender, or a health care facility, wherein the profile specific custom feeds comprise at least one of physician grades/ratings, regionalized health-related feeds, and financial services-specific consumer, physician, physician extender, or facility feeds.

44. The method of claim 38, wherein the processing comprises delivering at least one of profile-based recommendations, analytics functions, and region-based or financial services-based analytics functions to the user, a physician, a physician extender, or a facility.

45. The method of claim 38, wherein the processing comprises distributing an alert notification to a physician, a physician extender, or a facility in response to requirements of a physician profile, a physician extender profile, or a facility profile, respectively, and wherein the alert control center is further configured to manage time-based scheduling.

46. The method of claim 38, wherein the processing comprises monitoring and managing access of the user to the graphical user interface of the display.

47. The method of claim 38, wherein the processing comprises monitoring activity of the user to the graphical user interface of the display.

48. The method of claim 38, wherein the storing comprises storing the refined health information data for use by the graphical user interface.

49. The method of claim 38, wherein the transmitting comprises transmitting the refined health information data to the database storage unit for use by the graphical user interface configured to enable the user to access and manage the user's personal health record, locate a physician, a physician extender, or health care facility based on the user selected geographical area, and schedule an appointment with the physician, the physician extender, or the health care facility when the physician, the physician extender, or the health care facility is accepting new patients.

50. The method of claim 38, wherein the transmitting comprises transmitting the refined health information data to the database storage unit for use by the graphical user interface configured to enable a user, physician, a physician extender, or a facility to update information of a user profile, physician profile, a physician extender profile, or a facility profile, respectively.

51. The method of claim 38, wherein the user selected geographical area is based on at least one of a zip code, a physician first name, a physician last name, a physician city, or a physician state.

52. A method, comprising:
receiving raw health information data from a health information source;
processing the raw health information data by transforming the raw health information data into refined health information data;
storing the refined health information data; and
displaying the refined health information data to enable a user to access and manage health care needs of a user in a user selected geographical area.

53. The method of claim 52, wherein the receiving further comprises cleaning, collating, and cataloging the received raw health information data.

54. The method of claim 52, wherein the receiving comprises retrieving the raw health information data from the health information source.

55. The method of claim 52, wherein the receiving comprises storing the retrieved raw health information data.

56. The method of claim 52, wherein the health information source comprises at least one of a consumer health record, a facility record, a physician record, an insurance provider record, a healthcare benefits administration record, a health care knowledge base, non-U.S. multi-disciplinary data, a physician, a consumer, a facility administrator, and a physician extender.

57. The method of claim 52, wherein the processing comprises transforming the raw health information data into the refined health information data.

58. The method of claim 52, wherein the processing comprises the refined health information data.

59. The method of claim 52, wherein the processing comprises validating and testing the refined health information data for accuracy.

60. The method of claim 52, wherein the processing comprises facilitating the flow of raw health information data from the health information source through the receiver.

61. The method of claim 52, wherein the processing comprises consolidating the raw health information data received from the health information source, and further transmitting profile specific custom feeds to the user, a physician, a physician extender, or a health care facility, wherein the profile specific custom feeds comprise at least one of physician grades/ratings, regionalized health-related feeds, and financial services-specific consumer, physician, physician extender, or facility feeds.

62. The method of claim 52, wherein the processing comprises delivering at least one of profile-based recommendations, analytics functions, and region-based or financial services-based analytics functions to the user, a physician, a physician extender, or a facility.

63. The method of claim 52, wherein the processing comprises distributing an alert notification to a physician, a physician extender, or a facility in response to requirements of a physician profile, a physician extender profile, or a facility profile, respectively, and wherein the alert control center is further configured to manage time-based scheduling.

64. The method of claim 52, wherein the processing comprises monitoring and managing access of the user to a graphical user interface of the display.

65. The method of claim 52, wherein the processing comprises monitoring activity of the user to a graphical user interface of the display.

66. The method of claim 52, wherein the storing comprises storing the refined health information data for use by a graphical user interface of the display.

67. The method of claim 52, wherein the display comprises a graphical user interface.

68. The method of claim 52, wherein the displaying the refined health information data on a graphical user interface to enable the user to access and manage a personal health record, locate a physician, a physician extender, or a health care facility based on the user selected geographical area, and schedule an appointment with the physician, the physician extender, or the health care facility when the physician, the physician extender, or the health care facility is accepting new patients.

69. The method of claim 68, wherein the graphical user interface is configured to enable a user, a physician, a physician extender, or a facility to update information of a user profile, a physician profile, a physician extender profile, or a facility profile, respectively.

70. The method of claim 52, wherein the user selected geographical area is based on a zip code.

71. A computer program product embodied on a computer readable medium, the computer program product being configured to control a processor to perform:
receiving raw health information data from a health information source;
processing the raw health information data by transforming the raw health information data into refined health information data;
storing the refined health information data; and
displaying the refined health information data to enable a user to access and manage health care needs of the user in a user selected geographical area.
